(19) United States
(12) Patent Application Publication
(10) Pub. No.: US 2025/0379819 A1
(43) Pub. Date: Dec. 11, 2025

(54) DATA TRANSMISSION METHOD BASED ON CLOUD NETWORK, APPARATUS, ELECTRONIC DEVICE, AND STORAGE MEDIUM

(71) Applicant: Beijing Volcano Engine Technology Co., Ltd., Beijing (CN)

(72) Inventors: Dekui SUN, Beijing (CN); Can ZHUANG, Beijing (CN)

(21) Appl. No.: 19/056,004

(22) Filed: Feb. 18, 2025

(30) Foreign Application Priority Data
Jun. 5, 2024 (CN) 202410726382.X

(51) Int. Cl. H04L 45/76; H04L 45/00

(52) U.S. Cl. CPC H04L 45/76; H04L 45/54

(57) ABSTRACT

Embodiments of the present disclosure provide a data transmission method based on a cloud network, an apparatus, an electronic device, and a storage medium. The method includes: receiving first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification; and constructing a first-level query parameter based on the target address and the service object identification, and querying a first routing table based on the first-level query parameter to obtain a query result.

### CROSS-REFERENCE TO RELATED APPLICATION(S)

This application claims priority to Chinese Application No. 202410726382.X filed on Jun. 5, 2024, the disclosures of which are incorporated herein by reference in their entities.

### FIELD

Embodiments of the present disclosure relate to the technical field of cloud computing, and in particular, to a data transmission method based on a cloud network, an apparatus, an electronic device, and a storage medium.

### BACKGROUND

At present, in the technical field of cloud computing and cloud services, a technology of using a programmable switch as a cloud gateway of a public cloud has been applied on a large scale, and flexible and customizable data forwarding and processing capabilities can be implemented through the programmable switch.

In the prior art, based on service requirements of a large number of cloud server tenants, huge and complex network traffic generated by various virtualized service units is forwarded through a programmable switch, and customized routing rules in the programmable switch are used to implement efficient information forwarding.

### SUMMARY

Embodiments of the present disclosure provide a data transmission method based on a cloud network, an apparatus, an electronic device, and a storage medium.

According to a first aspect, an embodiment of the present disclosure provides a data transmission method based on a cloud network, including:
receiving first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification; constructing a first-level query parameter based on the target address and the service object identification, and querying a first routing table based on the first-level query parameter to obtain a query result, wherein the first routing table includes at least a target entry, the target entry is a query result corresponding to at least two first-level query parameters with different parameter values, and the target entry is used to jump to a second routing table; and in response to the query result being the target entry, obtaining a server address of the second virtualized service unit based on the second routing table, and sending the first communication data to the second virtualized service unit based on the server address.

According to a second aspect, an embodiment of the present disclosure provides a data transmission apparatus based on a cloud network, including:
a receiving module, configured to receive first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification;
a querying module, configured to construct a first-level query parameter based on the target address and the service object identification, and query a first routing table based on the first-level query parameter to obtain a query result, wherein the first routing table includes at least a target entry, the target entry is a query result corresponding to at least two first-level query parameters with different parameter values, and the target entry is used to jump to a second routing table; and
a processing module, configured to in response to the query result being the target entry, obtain a server address of the second virtualized service unit based on the second routing table, and send the first communication data to the second virtualized service unit based on the server address.

According to a third aspect, an embodiment of the present disclosure provides an electronic device, including: a processor and a memory;
where the memory stores a computer-executable instruction; and
the processor executes the computer-executable instruction stored in the memory, to cause the at least one processor to execute the data transmission method based on a cloud network according to the first aspect and various possible designs of the first aspect.

According to a fourth aspect, an embodiment of the present disclosure provides a computer-readable storage medium, wherein the computer-readable storage medium stores a computer-executable instruction, and when a processor executes the computer-executable instruction, the data transmission method based on a cloud network according to the first aspect and various possible designs of the first aspect is implemented.

According to a fifth aspect, an embodiment of the present disclosure provides a computer program product, including a computer program, wherein the computer program, when executed by a processor, implements the data transmission method based on a cloud network according to the first aspect and various possible designs of the first aspect.

According to the data transmission method based on a cloud network, the apparatus, the electronic device, and the storage medium provided in this embodiment, the first communication data sent by the first virtualized service unit is received, wherein the first communication data includes the target address and the service object identification, the target address is the virtual address of the second virtualized service unit that receives the first communication data, and the first virtualized service unit and the second virtualized service unit belong to the independent virtual network environment represented by the service object identification; the first-level query parameter is constructed based on the target address and the service object identification, and the first routing table is queried based on the first-level query parameter to obtain the query result, wherein the first routing table includes at least the target entry, the target entry is the query result corresponding to the at least two first-level query parameters with different parameter values, and the target entry is used to jump to the second routing table; and in response to the query result being the target entry, the server address of the second virtualized service unit is obtained based on the second routing table, and the first communication data is sent to the second virtualized service unit based on the server address. The first-level query parameter is constructed based on the first communication data, the first routing table obtained through query and modification is queried based on the first-level query parameter to obtain the target entry, and the target entry is used to jump to the second routing table, to complete the determination of the server address of the second virtualized service unit.

### BRIEF DESCRIPTION OF THE DRAWINGS

In order to illustrate the technical solutions in the embodiments of the present disclosure or in the prior art more clearly, the following briefly introduces the drawings required for describing the embodiments or the prior art. Apparently, the drawings in the following description show some embodiments of the present disclosure, and a person of ordinary skill in the art may still derive other drawings from these drawings without creative efforts.

FIG. 1 is a diagram of an application scenario of a data transmission method based on a cloud network according to an embodiment of the present disclosure;

FIG. 2 is a first flowchart of a data transmission method based on a cloud network according to an embodiment of the present disclosure;

FIG. 3 is a schematic diagram of a process of querying a first routing table according to an embodiment of the present disclosure;

FIG. 4 is a flowchart of specific implementation steps of constructing a first-level query parameter in step S102;

FIG. 5 is a flowchart of specific implementation steps of querying a first routing table in step S102;

FIG. 6 is a second flowchart of a data transmission method based on a cloud network according to an embodiment of the present disclosure;

FIG. 7 is a schematic diagram of generating a first routing table and a second routing table according to an embodiment of the present disclosure;

FIG. 8 is a flowchart of a specific implementation of step S206 in the embodiment shown in FIG. 6;

FIG. 9 is a schematic diagram of a process of querying a second routing table according to an embodiment of the present disclosure;

FIG. 10 is a block diagram of a structure of a data transmission apparatus based on a cloud network according to an embodiment of the present disclosure;

FIG. 11 is a schematic diagram of a structure of an electronic device according to an embodiment of the present disclosure; and

FIG. 12 is a schematic diagram of a hardware structure of an electronic device according to an embodiment of the present disclosure.

### DETAILED DESCRIPTION OF EMBODIMENTS

To make the objectives, technical solutions, and advantages of the embodiments of the present disclosure clearer, the following clearly and comprehensively describes the technical solutions in the embodiments of the present disclosure with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

It should be noted that user information (including but not limited to user device information, user personal information, and the like) and data (including but not limited to data for analysis, data for storage, data for display, and the like) involved in the present disclosure are information and data authorized by users or fully authorized by parties. In addition, the collection, use, and processing of related data need to comply with relevant laws, regulations, and standards in relevant countries and regions, and corresponding operation entrances are provided for users to choose to authorize or reject.

At present, in the technical field of cloud computing and cloud services, a technology of using a programmable switch as a cloud gateway of a public cloud has been applied on a large scale, and flexible and customizable data forwarding and processing capabilities can be implemented through the programmable switch.

In the prior art, based on service requirements of a large number of cloud server tenants, huge and complex network traffic generated by various virtualized service units is forwarded through a programmable switch, and customized routing rules in the programmable switch are used to implement efficient information forwarding.

However, due to limited cache resources of the programmable switch currently applied, there is a problem that large-scale services cannot be supported.

Embodiments of the present disclosure provide a data transmission method based on a cloud network, an apparatus, an electronic device, and a storage medium, to overcome the problem of inability to support large-scale services.

According to the data transmission method based on a cloud network, the apparatus, the electronic device, and the storage medium provided in this embodiment, the first communication data sent by the first virtualized service unit is received, wherein the first communication data includes the target address and the service object identification, the target address is the virtual address of the second virtualized service unit that receives the first communication data, and the first virtualized service unit and the second virtualized service unit belong to the independent virtual network environment represented by the service object identification; the first-level query parameter is constructed based on the target address and the service object identification, and the first routing table is queried based on the first-level query parameter to obtain the query result, wherein the first routing table includes at least the target entry, the target entry is the query result corresponding to the at least two first-level query parameters with different parameter values, and the target entry is used to jump to the second routing table; and in response to the query result being the target entry, the server address of the second virtualized service unit is obtained based on the second routing table, and the first communication data is sent to the second virtualized service unit based on the server address. The first-level query parameter is constructed based on the first communication data, the first routing table obtained through query and modification is queried based on the first-level query parameter to obtain the target entry, and the target entry is used to jump to the second routing table, to complete the determination of the server address of the second virtualized service unit. Because the target entry in the first routing table corresponds to multiple first-level query parameters, fewer entries can be utilized to complete coverage of more query parameters, thereby reducing the number of entries in the first routing table, and then achieving the goal of saving cache resources of the programmable switch and improving the scale of services supported by the programmable switch.

An application scenario of this embodiment of the present disclosure is described below.

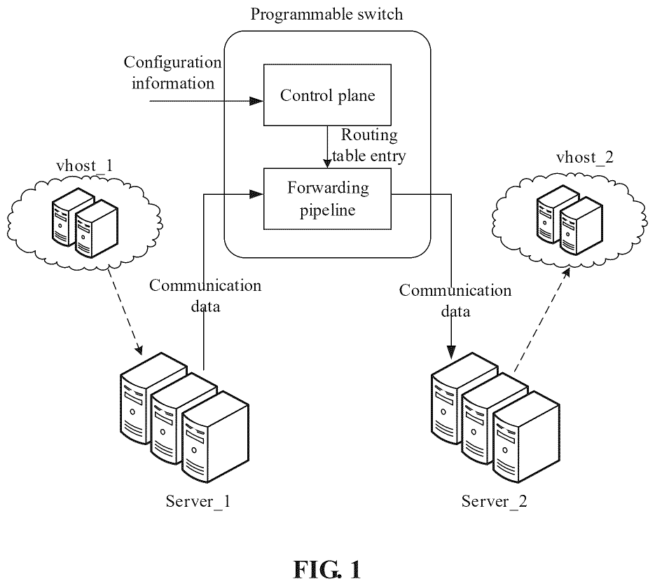

FIG. 1 is a diagram of an application scenario of a data transmission method based on a cloud network according to an embodiment of the present disclosure. The data transmission method based on a cloud network provided in this embodiment of the present disclosure may be applied to an application scenario of cloud services and cloud computing, and more specifically, may be applied to data forwarding by using a programmable switch as a cloud gateway. An execution body of this embodiment may be a network device with a function of the programmable switch, or another electronic device with a similar function.

For example, in some embodiments, the network device or the electronic device may implement the data transmission method based on a cloud network provided in this embodiment of the present disclosure by running various computer-executable instructions or computer programs. For example, the computer-executable instruction may be a program-level command, a machine instruction, or a software instruction. The computer program may be a native program or a software module in an operating system, or may be a local application, that is, a program that needs to be installed in the operating system to run. In conclusion, the above computer-executable instruction may be an instruction in any form, and the above computer program may be an application, a module, or a plug-in in any form, and a specific implementation form may be configured based on a requirement. Further, in application scenarios of cloud computing and cloud services, the network device or the electronic device communicates with a server, and forwards data generated by the server. In some embodiments, the server may be an independent physical server, or may be a server cluster or a distributed system including a plurality of physical servers, or may be a cloud server that provides basic cloud computing services such as cloud services, cloud storage, cloud communication, cloud databases, cloud computing, cloud functions, network services, middleware services, domain name services, security services, content delivery network (CDN), and big data and artificial intelligence platforms.

Referring to FIG. 1, taking the network device as an example, the network device is, for example, the programmable switch, for example, a P4 switch. In the application scenario of cloud computing, a corresponding virtual machine, container, or virtualized service unit (hereinafter collectively referred to as a virtualized service unit) is created by a cloud server (physical machine). When data communication is performed between virtualized service units created by different cloud servers, data forwarding needs to be performed by using the above programmable switch. For example, as shown in the figure, when the virtualized service unit vhost_1 created by the server Server_1 communicates with the virtualized service unit vhost_2 created by the server Server_2, configuration information needs to be delivered to a control plane of the programmable switch first. After that, the control plane of the programmable switch converts tenant information of a cloud server tenant into a routing table entry and delivers the routing table entry to a forwarding pipeline. Then, after the virtualized service unit vhost_1 sends communication data to the forwarding pipeline of the programmable switch by using the server Server_1, a server address corresponding to the server Server_2 is determined by using a routing rule represented by the delivered routing table entry. Then, the communication data is forwarded to the server Server_2 that creates the virtualized service unit vhost_2, to complete a process of sending the communication data from the virtualized service unit vhost_1 to the virtualized service unit vhost_2.

In the prior art, after huge and complex network traffic generated by various virtualized service units in the cloud service scenario is sent to the programmable switch, the routing rule represented by the routing table entry in the programmable switch is used to send data. However, due to limited cache resources of the programmable switch, a large number of routing table entries cannot be stored to meet service requirements of large-scale and multi-tenant, resulting in a problem that the programmable switch cannot support large-scale services.

This embodiment of the present disclosure provides a data transmission method based on a cloud network to solve the above problem.

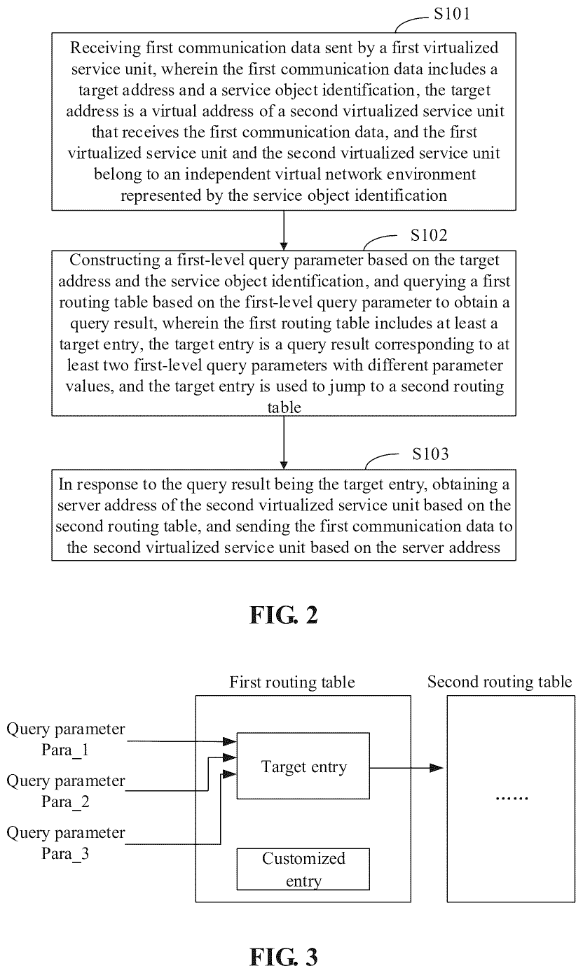

Referring to FIG. 2, FIG. 2 is a first flowchart of a data transmission method based on a cloud network according to an embodiment of the present disclosure. The method in this embodiment may be applied to a programmable switch, and the data transmission method based on a cloud network includes the following steps.

Step S101: receiving first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification.

Exemplarily, referring to the schematic diagram of the application scenario shown in FIG. 1, an execution body of the method provided in this embodiment is the programmable switch. After receiving the first communication data sent by the first virtualized service unit, the programmable switch parses the first communication data, to obtain the target address and the service object identification. The first virtualized service unit and the subsequent second virtualized service unit are both virtualized service units. The virtualized service unit may be a virtual machine, a cloud server, a container, or another virtualized service unit. More specifically, for example, an elastic compute service (ECS) is used. A user creates and releases a cloud server by renting the elastic compute service, to implement deployment of a required service capability. The foregoing virtualized service unit is an existing technical concept in the cloud service and cloud computing scenarios, and details are not described herein again. Further, the first communication data includes the target address and the service object identification. The target address is the virtual address of the second virtualized service unit that receives the first communication data, that is, the destination address of the first communication data. The service object identification is used to represent different cloud server tenants. Because the different cloud server tenants need to configure corresponding routing rules based on their service requirements, the different cloud server tenants can be identified through the service object identification. Further, exemplarily, in a virtual private cloud (VPC), the service object identification may be a VXLAN network identifier (VNI). The VNI is an identification of each VXLAN segment, and is a 24-bit integer. Each VNI usually corresponds to one tenant. A large number of independent virtual network environments can be supported through a public cloud built by using VXLAN. In the virtual private cloud, each cloud server tenant has an independent virtual network environment isolated from each other, and the independent virtual network environment (that is, the cloud server tenant) can be distinguished through the VXLAN network identifier. The VXLAN is an existing network virtualization technology, and details are not described herein again.

Specifically, for example, the virtual address of the first virtualized service unit is 192.168.1.1, and the virtual address of the second virtualized service unit is 192.168.1.2. The first communication data sent by the first virtualized service unit to the second virtualized service unit includes the target address: 192.168.1.2, that is, the virtual address of the second virtualized service unit, and the service object identification vni_1=vpc_vni(001). The first virtualized service unit and the second virtualized service unit both belong to the independent virtual network environment represented by the service object identification vni_1. Certainly, in another possible implementation, the first communication data may further include a source address of the first communication data, that is, the virtual address 192.168.1.1 of the first virtualized service unit, in addition to the foregoing information.

It should be noted that in addition to the foregoing routing information such as the target address, the source address, and the service object identification that is used for communication, the first communication data may further include specific service information, such as a service request instruction and service data. Finally, the foregoing specific service request information and service data are sent to the second virtualized service unit, to complete data communication between the first virtualized service unit and the second virtualized service unit.

Step S102: constructing a first-level query parameter based on the target address and the service object identification, and querying a first routing table based on the first-level query parameter to obtain a query result, wherein the first routing table includes at least a target entry, the target entry is a query result corresponding to at least two first-level query parameters with different parameter values, and the target entry is used to jump to a second routing table.

Further, after the target address and the service object identification are obtained through parsing the first communication data, the query parameter, that is, the first-level query parameter, is constructed by using the target address and the service object identification. The first-level query parameter may be understood as a query parameter with a specific special data structure. The first routing table is queried by using the first-level query parameter, so that a routing rule in the first routing table can be hit, and data routing is implemented. Exemplarily, the first routing table is a form used to record a data routing rule. The first routing table includes a plurality of entries, and each entry corresponds to one routing rule. After the first routing table is queried based on the query parameter, the hit entry is executed, so that data forwarding is performed based on the corresponding routing rule. In the solution provided in this embodiment, the first routing table includes at least one special target entry. The target entry is a query result corresponding to at least two first-level query parameters with different parameter values. After the target entry is hit, a jump is performed to the second routing table. Then, the server address is further determined based on the routing rule recorded in the second routing table, and data forwarding is completed. Specifically, the same target entry may be hit after the first routing table is queried by using a plurality of different first-level query parameters, and then the target entry is used to jump to the corresponding second routing table for subsequent routing processing.

FIG. 3 is a schematic diagram of a process of querying a first routing table according to an embodiment of the present disclosure. Referring to FIG. 3, when the first routing table is queried by using the first-level query parameters with different values, for example, the query parameter Para_1, the query parameter Para_2, and the query parameter Para_3, the target entry Key_0 is hit. After that, a jump action corresponding to the target entry Key_0 is performed to jump to the second routing table, and a subsequent step is performed. Based on the foregoing introduction, at least one of the target address and the service object identification in the query parameter Para_1, the query parameter Para_2, and the query parameter Para_3 is different. More specifically, for example, the service object identification of the query parameter Para_1 is vni_1, the service object identification of the query parameter Para_2 is vni_2, and the service object identification of the query parameter Para_3 is vni_3, corresponding to three different independent virtual network environments and cloud server tenants. However, final query results are the same target entry Key_0. In the step of this embodiment, because the target entry in the first routing table corresponds to multiple first-level query parameters, fewer entries can be utilized to complete coverage of more first-level query parameters. In practical applications, for example, the target entry may cover thousands of first-level query parameters, so that the number of entries in the first routing table can be greatly reduced.

Further, in a possible implementation, the first routing table is stored in a ternary content addressable memory (TCAM) in the programmable switch. The ternary content addressable memory is a high-speed and high-density hardware memory, and has a core feature that access is performed by using content as an address. Thanks to its capability of high-speed matching and parallel search, it can simultaneously query a plurality of addresses in a single clock cycle, thereby improving routing query capability of the programmable switch. However, the ternary content addressable memory has a feature of a small amount of resources. In view of this feature, in this embodiment, the first routing table including the special target entry is stored in the programmable switch. On the one hand, due to the reduced size of the first routing table, the first routing table can be normally set in the ternary content addressable memory, so that a problem of a small amount of resources of the ternary content addressable memory is avoided. On the other hand, the access and query speed of the first routing table is improved.

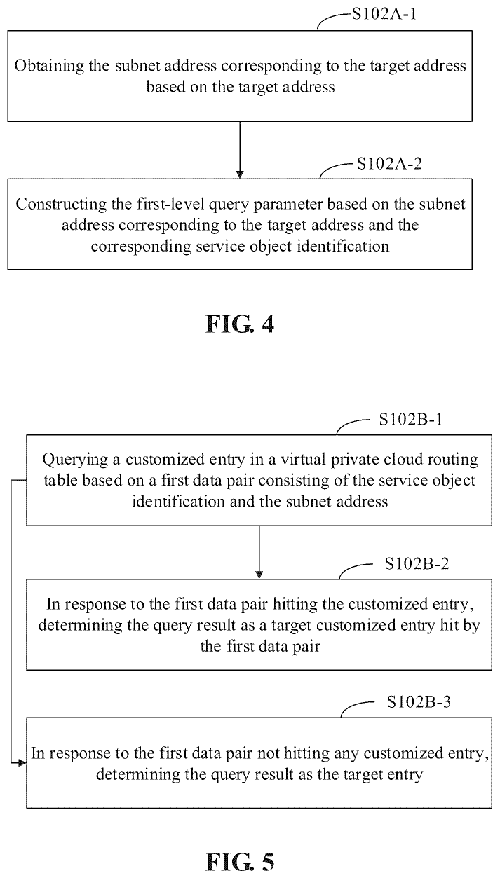

Further, in a possible implementation, the first routing table is a virtual private cloud routing table, and the first-level query parameter includes a subnet address corresponding to the target address and the service object identification. As shown in FIG. 4, the specific implementation of constructing the first-level query parameter based on the target address and the service object identification includes the following steps.

Step S102A-1: obtaining the subnet address corresponding to the target address based on the target address.

Step S102A-2: constructing the first-level query parameter based on the subnet address corresponding to the target address and the corresponding service object identification.

The subnet address is an address interval, which defines a range of network addresses (virtual addresses) that can be used by the virtualized service unit and reachability of other virtualized service units in the subnet. The virtualized service unit and other nodes in the subnet in which the virtualized service unit is located may usually directly access each other through Layer 2 communication. After the subnet address is determined based on the target address, the subnet address and the service object identification are combined into a data pair to construct the first-level query parameter.

Correspondingly, as shown in FIG. 5, the specific implementation of querying the first routing table based on the first-level query parameter to obtain the query result in step S102 includes the following steps.

Step S102B-1: querying a customized entry in a virtual private cloud routing table based on a first data pair consisting of the service object identification and the subnet address.

Step S102B-2: in response to the first data pair hitting the customized entry, determining the query result as a target customized entry hit by the first data pair.

Step S102B-3: in response to the first data pair not hitting any customized entry, determining the query result as the target entry.

Exemplarily, the customized entry in the virtual private cloud (VPC) routing table is queried through the first data pair consisting of the service object identification and the subnet address in the first-level query parameter. The customized entry may be understood as an entry other than the target entry. In another possible implementation, the first routing table includes one target entry and at least one customized entry. The customized entry is searched for by using the first data pair first. If the customized entry is hit, subsequent data routing is performed based on an execution action corresponding to the customized entry. If the customized entry is not hit, it is considered that the target entry is hit, and then the execution action corresponding to the target entry is performed.

In the step of this embodiment, in the process of querying the first routing table (the virtual private cloud routing table), the target entry is triggered (determined to be hit) by using fewer customized entries first and a query result of the customized entry. In this manner, on the one hand, because there are few customized entries or even no customized entry, this is equivalent to a reverse exclusion search method. Compared with conventional forward search, time consumed for querying the first routing table is greatly reduced, the query efficiency of the first routing table is improved, and resource occupation and maintenance costs of the first routing table are reduced.

Step S103: in response to the query result being the target entry, obtaining a server address of the second virtualized service unit based on the second routing table, and sending the first communication data to the second virtualized service unit based on the server address.

Exemplarily, after the first routing table is queried based on the first-level query parameter to obtain the query result, in a possible implementation, the target entry is hit through the query of the first-level query parameter, that is, the query result is the target entry. In this case, the server address of the second virtualized service unit is obtained by further querying the second routing table. Because the target entry can cover a plurality of first-level query parameters, this case is a case that has a high probability of occurrence. Specifically, the second routing table records rules for mapping the server address in different independent virtual network environments (cloud server tenants), that is, the second routing table is used to represent the mapping relationship between the virtual address belonging to the different subnet address and the corresponding server address in the independent virtual network environment. The corresponding second-level query parameter is constructed by using the target address and the service object identification in the first communication data, and the second routing table is queried, so that the server address of the second virtualized service unit can be obtained. After that, the first communication data can be sent to the second virtualized service unit based on the server address.

In a possible implementation, the second routing table is a virtual machine location (vm location) table, which is a hash exact matching table and is used to indicate a location of the server to which the virtualized service unit belongs. The second routing table is stored in a static random access memory (SRAM) in the programmable switch. Compared with the ternary content addressable memory, the static random access memory has more abundant available resources, and therefore can store more routing mapping relationships. With reference to the introduction in the previous steps, the second routing table records richer mapping relationships, and therefore has a larger data size. The second routing table is stored in the static random access memory, so that the feature of abundant resources of the static random access memory is fully utilized, thereby implementing support for a larger scale of independent virtual network environments and cloud server tenants.

According to the data transmission method based on a cloud network provided in this embodiment, the first communication data sent by the first virtualized service unit is received, wherein the first communication data includes the target address and the service object identification, the target address is the virtual address of the second virtualized service unit that receives the first communication data, and the first virtualized service unit and the second virtualized service unit belong to the independent virtual network environment represented by the service object identification; the first-level query parameter is constructed based on the target address and the service object identification, and the first routing table is queried based on the first-level query parameter to obtain the query result, wherein the first routing table includes at least the target entry, the target entry is the query result corresponding to the at least two first-level query parameters with different parameter values, and the target entry is used to jump to the second routing table; and in response to the query result being the target entry, the server address of the second virtualized service unit is obtained based on the second routing table, and the first communication data is sent to the second virtualized service unit based on the server address. The first-level query parameter is constructed based on the first communication data, the first routing table obtained through query and modification is queried based on the first-level query parameter to obtain the target entry, and the target entry is used to jump to the second routing table, to complete the determination of the server address of the second virtualized service unit. Because the target entry in the first routing table corresponds to multiple first-level query parameters, fewer entries can be utilized to complete coverage of more query parameters, thereby reducing the number of entries in the first routing table, and then achieving the goal of saving cache resources of the programmable switch and improving the scale of services supported by the programmable switch.

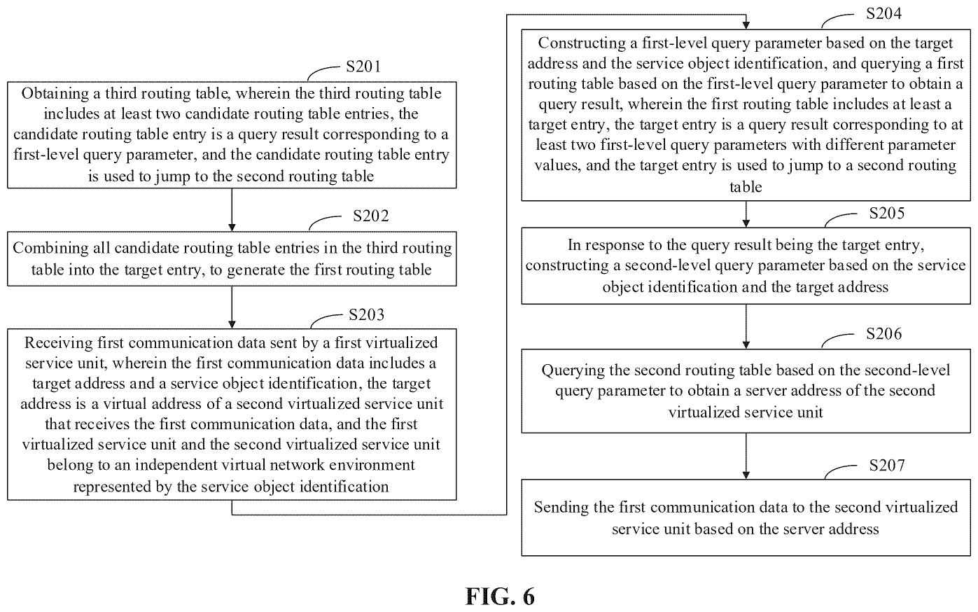

Referring to FIG. 6, FIG. 6 is a second flowchart of a data transmission method based on a cloud network according to an embodiment of the present disclosure. On the basis of the embodiment shown in FIG. 2, this embodiment further refines step S103, and adds a process of configuring the first routing table and the second routing table. The data transmission method based on a cloud network includes the following steps.

Step S201: obtaining a third routing table, wherein the third routing table includes at least two candidate routing table entries, the candidate routing table entry is a query result corresponding to a first-level query parameter, and the candidate routing table entry is used to jump to the second routing table based on the first-level query parameter.

Step S202: combining all candidate routing table entries in the third routing table into the target entry, to generate the first routing table.

Exemplarily, in this embodiment, before performing data routing and forwarding, the programmable switch as the execution body may first obtain the third routing table. The third routing table may be understood as a conventional routing table in the prior art, for example, stored in a ternary content addressable memory. The third routing table includes at least two candidate routing table entries, and each candidate routing table entry is a query result of one unique first-level query parameter. Based on the introduction in the previous embodiment, the first-level query parameter has a corresponding relationship with the independent virtual network environment. Therefore, the independent virtual network environment and the candidate routing table entry also have a one-to-one corresponding relationship. Due to the above features, the third routing table has a problem of data size. In the step of this embodiment, the corresponding instruction or program is notified and executed for the third routing table in the programmable switch, to combine all candidate routing table entries in the third routing table into at least one target entry, to generate the first routing table. A specific combining manner may be set based on a requirement, for example, combining is performed based on cloud server tenant information corresponding to a cloud server tenant, which is not described herein again. After the combining, the third routing table with a large number of entries forms the first routing table with fewer entries, thereby implementing resource release of the ternary content addressable memory.

Further, in a possible implementation, the candidate routing table entry is used to jump to a fourth routing table, that is, a lower-level routing table of the third routing table is the fourth routing table. After the first routing table is generated by combining the third routing table, when lower-level routing tables of the third routing table in the system exist in a form of the fourth routing table, the second routing table may be generated by further combining a plurality of fourth routing tables. Specifically, the candidate routing table entry in the third routing table is used to jump to the fourth routing table, and the fourth routing table is stored in a static random access memory of the programmable switch. The fourth routing table is used to represent a mapping relationship between the virtual address belonging to the same target subnet address and the corresponding server address in the target independent virtual network environment indicated by the first-level query parameter, that is, the mapping relationship between the server address and the data pair consisting of the service object identification and the subnet address. The fourth routing tables corresponding to the candidate entries are combined to form a larger routing table, that is, the second routing table. Through the foregoing steps, the first routing table used in the embodiment shown in FIG. 2 and the corresponding second routing table are formed.

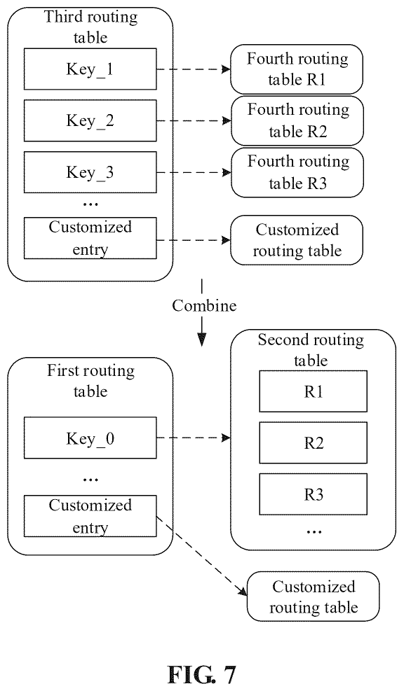

FIG. 7 is a schematic diagram of generating a first routing table and a second routing table according to an embodiment of the present disclosure. As shown in FIG. 7, exemplarily, on the basis of obtaining the fourth routing table having the mapping relationship with the third routing table, in response to execution of a configuration program, a plurality of candidate routing table entries in the third routing table as shown in the figure, for example, candidate routing table entries Key_1, Key_2, Key_3, and the like (shown as Key_1, Key_2, and Key_3 in the figure) are first combined into a target entry Key_0. After that, the fourth routing tables corresponding to the candidate routing table entries Key_1, Key_2, and Key_3, for example, the fourth routing table R1, the fourth routing table R2, and the fourth routing table R3 as shown in the figure, are combined as entries to generate the second routing table. The second routing table includes, for example, the entries R1, R2, and R3, to inherit the routing rules of the foregoing fourth routing tables. On this basis, the customized entry in the original third routing table and the customized routing table invoked after the customized entry is hit are retained and still stored in the first routing table.

Optionally, this embodiment further includes (not shown in the figure):

Step S200: obtaining service object configuration information delivered to a control plane of the programmable switch, wherein the service object configuration information is used to register the service object identification; and generating or updating the second routing table based on the service object configuration information.

Exemplarily, before or after the first routing table and the second routing table are formed, the service object configuration information delivered to the control plane of the programmable switch is obtained. The service object configuration information is used to register the service object identification, that is, register an independent virtual network environment for the service object (the cloud server tenant), thereby providing a private cloud service for the service object. After obtaining the service object configuration information delivered by the control plane, the programmable switch adds a routing rule corresponding to the registered service object identification based on the registered service object identification. For example, a routing rule R1 is added to the service object identification vni_1, and an entry is formed and recorded in the second routing table, to complete a process of generating or updating the second routing table. Through the steps of this embodiment, the real-time update of the second routing table is implemented, the accuracy of the routing rule is improved, and the correctness of the data forwarding process is ensured. This step may be performed before step S201 or after step S202, which is not limited.

Step S203: receiving first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification.

Step S204: constructing a first-level query parameter based on the target address and the service object identification, and querying a first routing table based on the first-level query parameter to obtain a query result, wherein the first routing table includes at least a target entry, the target entry is a query result corresponding to at least two first-level query parameters with different parameter values, and the target entry is used to jump to a second routing table.

Step S205: in response to the query result being the target entry, constructing a second-level query parameter based on the service object identification and the target address.

Step S206: querying the second routing table based on the second-level query parameter to obtain a server address of the second virtualized service unit.

Exemplarily, in a possible case, in response to the query result being the target entry, that is, the target entry is hit, the second-level query parameter is further constructed based on the service object identification and the target address, so that the second-level query parameter can represent the target address and the service object identification. After that, the server address of the second virtualized service unit is obtained by using the mapping relationship between the virtual address belonging to the different subnet address and the corresponding server address in the independent virtual network environment represented by the second routing table.

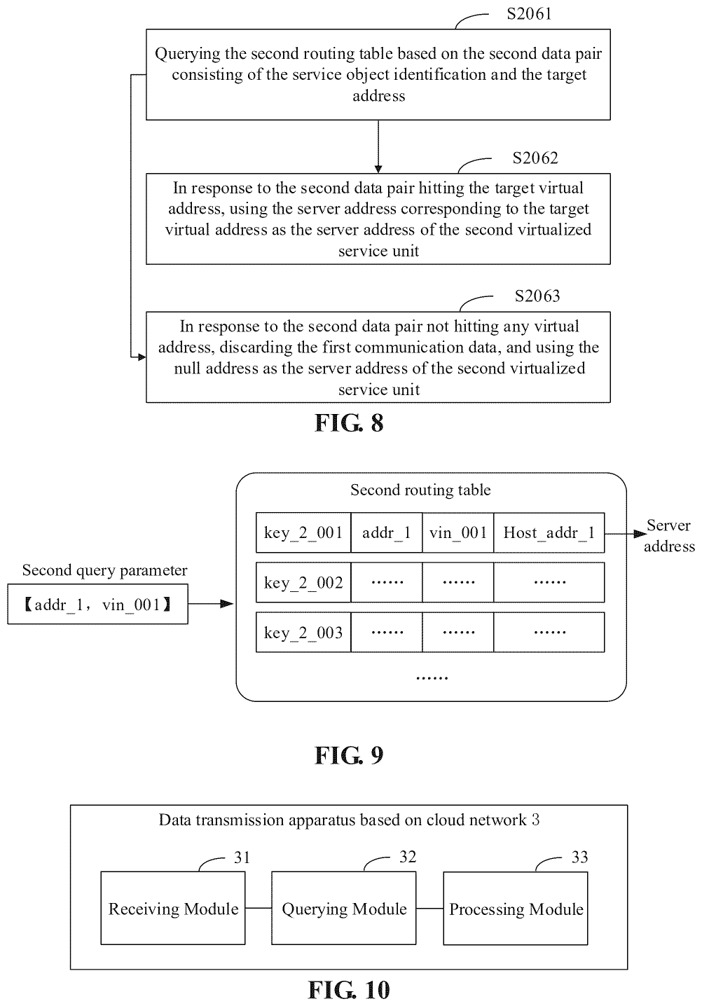

Further, as shown in FIG. 8, the specific implementation of step S206 includes the following steps.

Step S2061: querying the second routing table based on a second data pair consisting of the service object identification and the target address.

Step S2062: in response to the second data pair hitting a target virtual address, using a server address corresponding to the target virtual address as the server address of the second virtualized service unit.

Step S2063: in response to the second data pair not hitting any virtual address, discarding the first communication data, and using a null address as the server address of the second virtualized service unit.

Exemplarily, first, the second data pair is constructed based on the service object identification and the target address in the second-level query parameter, for example, [target address, service object identification]. After that, the second routing table is queried by using the second-level query parameter. In response to the second data pair hitting the target virtual address, the accurate server address, that is, the server address of the physical server where the second virtualized service unit is located, may be obtained. On the contrary, if the second data pair does not hit the target virtual address, it indicates that the corresponding routing rule is not recorded in the second routing table (editable switch). In this case, the first communication data is discarded, and a processing request for the first communication data is ignored.

FIG. 9 is a schematic diagram of a process of querying a second routing table according to an embodiment of the present disclosure. The foregoing process is described below with reference to FIG. 9. Exemplarily, first, the second data pair [addr_1, vin_001] in the second-level query parameter is obtained. After that, the second routing table is queried based on the second data pair. The second routing table includes a plurality of entries such as an entry key_2_001, an entry key_2_002, and an entry key_2_003. Each entry includes two condition fields and one action field. The condition field is in a form of [X, Y], wherein X represents the service object identification, and Y represents the virtual address. For example, as shown in the figure, the second data pair [addr_1, vin_001] hits the condition field [addr_1, vin_001] of the entry key_2_001 in the second routing table, that is, the service object identification in the second data pair is the same as content representing the service object identification in the condition field in the entry in the second routing table, and the target address in the second data pair is the same as content representing the virtual address in the condition field in the entry in the second routing table. In this case, it is considered that the second data pair hits the target virtual address. After that, the server address Host_addr_1 mapped by the entry key_2_001 is determined as the server address of the second virtualized service unit.

It should be noted that compared with the first-level query parameter, the second-level query parameter includes the specific target address, and the subnet address of the target address may actually be a part of the target address. For example, if the target address is 192.168.1.2, 192.168.1 is the subnet address. Therefore, the second-level query parameter includes information in the first-level query parameter. Therefore, in the process of directly querying the second routing table by using the second-level query parameter to determine the server address, information loss is not caused, and the accuracy of the routing result is ensured.

Step S207: sending the first communication data to the second virtualized service unit based on the server address.

In this embodiment, steps S203, S204, and S207 are implemented in the same manner as corresponding parts of steps S101 to S103 in the embodiment shown in FIG. 2 of the present disclosure, and details are not described herein again.

Corresponding to the data transmission method based on a cloud network in the foregoing embodiment, FIG. 10 is a block diagram of a structure of a data transmission apparatus based on a cloud network according to an embodiment of the present disclosure. The method described in the foregoing embodiment may be executed by the data transmission apparatus based on a cloud network. The apparatus may be implemented in a software and/or hardware manner, and may be integrated into an electronic device with a specific data processing function. For example, the electronic device may include, but is not limited to, a mobile terminal with big data processing capabilities, and a fixed terminal with big data processing capabilities such as a desktop computer and a supercomputer.

For ease of description, only parts related to the embodiments of the present disclosure are shown. Referring to FIG. 10, the data transmission apparatus 3 based on a cloud network includes:

a receiving module 31, configured to receive first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification;
a querying module 32, configured to construct a first-level query parameter based on the target address and the service object identification, and query a first routing table based on the first-level query parameter to obtain a query result, wherein the first routing table includes at least a target entry, the target entry is a query result corresponding to at least two first-level query parameters with different parameter values, and the target entry is used to jump to a second routing table; and
a processing module 33, configured to in response to the query result being the target entry, obtain a server address of the second virtualized service unit based on the second routing table, and send the first communication data to the second virtualized service unit based on the server address.

According to one or more embodiments of the present disclosure, the first routing table is stored in a ternary content addressable memory of a programmable switch, and the second routing table is stored in a static random access memory of the programmable switch.

According to one or more embodiments of the present disclosure, the first routing table is a virtual private cloud routing table, and the first-level query parameter includes a subnet address corresponding to the target address and the service object identification; and when querying the first routing table based on the first-level query parameter to obtain the query result, the querying module 32 is further configured to: query a customized entry in the virtual private cloud routing table based on a first data pair consisting of the service object identification and the subnet address; and in response to the first data pair hitting the customized entry, determining the query result as a target customized entry hit by the first data pair, or in response to the first data pair not hitting any customized entry, determining the query result as the target entry.

According to one or more embodiments of the present disclosure, the second routing table is used to represent a mapping relationship between a virtual address belonging to a different subnet address and a corresponding server address in the independent virtual network environment, and obtaining the server address of the second virtualized service unit based on the second routing table includes: constructing a second-level query parameter based on the service object identification and the target address; and querying the second routing table based on the second-level query parameter to obtain the server address of the second virtualized service unit.

According to one or more embodiments of the present disclosure, when querying the second routing table based on the second-level query parameter to obtain the server address of the second virtualized service unit, the processing module 33 is further configured to: query the second routing table based on a second data pair consisting of the service object identification and the target address; in response to the second data pair hitting a target virtual address, using a server address corresponding to the target virtual address as the server address of the second virtualized service unit; or in response to the second data pair not hitting any virtual address, discarding the first communication data.

According to one or more embodiments of the present disclosure, the processing module 33 is further configured to: obtain service object configuration information delivered to a control plane of the programmable switch, wherein the service object configuration information is used to register the service object identification; and generate or update the second routing table based on the service object configuration information.

According to one or more embodiments of the present disclosure, the processing module 33 is further configured to: obtain a third routing table, wherein the third routing table includes at least two candidate routing table entries, the candidate routing table entry is a query result corresponding to a first-level query parameter, and the candidate routing table entry is used to jump to a fourth routing table, wherein the fourth routing table is used to represent a mapping relationship between a virtual address belonging to a same target subnet address and a corresponding server address in a target independent virtual network environment indicated by the first-level query parameter; combine all candidate routing table entries in the third routing table into a target entry, to generate the first routing table; and combine each fourth routing table based on the independent virtual network environment and the corresponding subnet address, to generate the second routing table.

The receiving module 31, the querying module 32 and the processing module 33 are connected in sequence. The data transmission apparatus 3 based on a cloud network provided in this embodiment can implement the technical solutions of the foregoing method embodiments, and the implementation principles and technical effects thereof are similar, which are not described herein again in this embodiment.

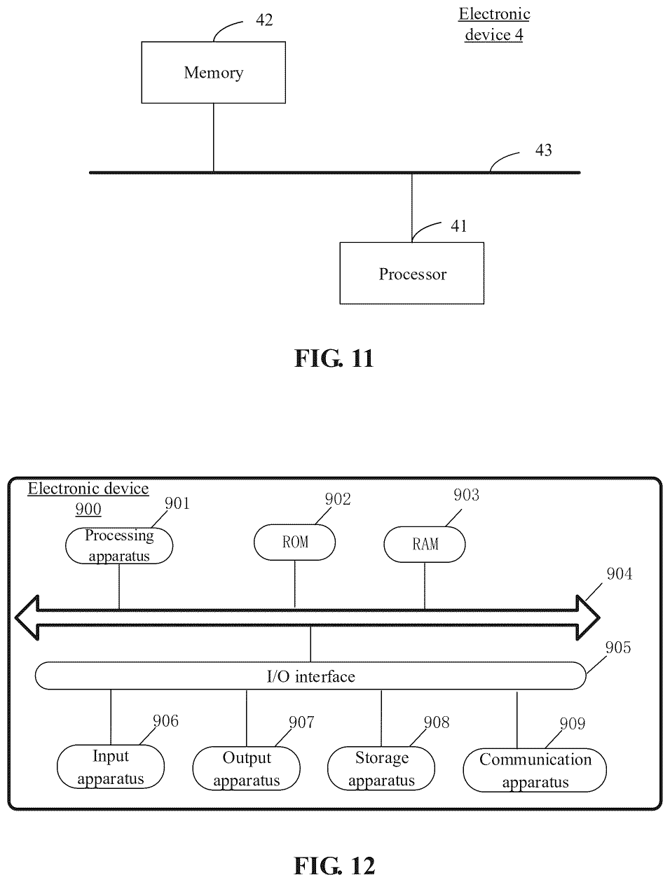

FIG. 11 is a schematic diagram of a structure of an electronic device according to an embodiment of the present disclosure. As shown in FIG. 11, the electronic device 4 includes:
a processor 41 and a memory 42 in communication connection with the processor 41;
where the memory 42 stores a computer-executable instruction; and
the processor 41 executes the computer-executable instruction stored in the memory 42 to implement the data transmission method based on a cloud network in the embodiments shown in FIG. 2 to FIG. 9.

Optionally, the processor 41 and the memory 42 are connected through a bus 43.

For related explanations, reference may be made to the related descriptions and effects corresponding to the steps in the embodiments shown in FIG. 2 to FIG. 9 for understanding, which are not described herein again.

An embodiment of the present disclosure provides a computer-readable storage medium. The computer-readable storage medium stores a computer-executable instruction, and the computer-executable instruction, when executed by a processor, is used to implement the data transmission method based on a cloud network according to any of the embodiments shown in FIG. 2 to FIG. 9 in the present disclosure.

An embodiment of the present disclosure provides a computer program product, including a computer program, wherein the computer program, when executed by a processor, implements the data transmission method based on a cloud network according to any of the embodiments shown in FIG. 2 to FIG. 9 in the present disclosure.

To implement the foregoing embodiments, an embodiment of the present disclosure further provides an electronic device.

Referring to FIG. 12, it illustrates a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (abbreviated as PDA), a tablet computer, a portable media player (abbreviated as PMP) and a vehicle-mounted terminal (such as a vehicle navigation terminal), and a fixed terminal such as a digital TV and a desktop computer. The electronic device shown in FIG. 12 is only an example, and should not impose any limitation on the function and scope of use of the embodiments of the present disclosure.

As shown in FIG. 12, the electronic device 900 may include a processing apparatus (such as a central processing unit and a graphics processor) 901, which may perform various suitable actions and processing according to a program stored in a read-only memory (abbreviated as ROM) 902 or a program loaded from a storage apparatus 908 into a random access memory (abbreviated as RAM) 903. The RAM 903 further stores various programs and data required for the operation of the electronic device 900. The processing apparatus 901, the ROM 902 and the RAM 903 are connected to each other through a bus 904. An input/output (I/O) interface 905 is also connected to the bus 904.

Generally, the following apparatus may be connected to the I/O interface 905: an input apparatus 906 including, for example, a touch screen, a touch pad, a keyboard, a mouse, a camera, a microphone, an accelerometer, a gyroscope, etc.; an output apparatus 907 including, for example, a liquid crystal display (abbreviated as LCD), a speaker, a vibrator, etc.; a storage apparatus 908 including, for example, a magnetic tape, a hard disk, etc.; and a communication apparatus 909. The communication apparatus 909 may allow the electronic device 900 to perform wireless or wired communication with other devices to exchange data. Although FIG. 12 shows the electronic device 900 having various apparatuses, it should be understood that not all of the illustrated apparatuses are necessarily implemented or provided. Alternatively, more or fewer apparatuses may be implemented or provided.

Particularly, according to the embodiments of the present disclosure, the process described above with reference to the flowchart may be implemented as a computer software program. For example, an embodiment of the present disclosure includes a computer program product, which includes a computer program carried on a computer-readable medium. The computer program includes program codes for executing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above functions defined in the method of the embodiments of the present disclosure are performed.

It should be noted that the above computer-readable medium in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium including or storing a program. The program may be used by or used in conjunction with an instruction execution system, apparatus or device. In the present disclosure, the computer-readable signal medium may include a data signal propagated in baseband or as a part of a carrier wave, and computer-readable program codes are carried therein. This propagated data signal may take many forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or used in conjunction with an instruction execution system, apparatus or device. The program codes contained in the computer-readable medium may be transmitted by using any suitable medium, including but not limited to an electrical wire, an optical cable, radio frequency (RF), etc., or any suitable combination thereof.

The above computer-readable medium may be included in the above electronic device, or may exist alone without being assembled into the electronic device.

The above computer-readable medium carries one or more programs, and when the one or more programs are executed by the electronic device, the electronic device is caused to execute the method shown in the foregoing embodiments.

The computer program codes for performing the operations in the present disclosure may be written in one or more programming languages or a combination thereof. The foregoing programming languages include object-oriented programming languages such as Java, Smalltalk, and C++, and further include conventional procedural programming languages such as C or similar programming languages. The program code may be executed entirely on a user computer, executed partly on a user computer, executed as a stand-alone software package, executed partly on a user computer and partly on a remote computer, or executed entirely on a remote computer or a server. In a case involving the remote computer, the remote computer may be connected to the user computer through any type of network, including a local area network (abbreviated as LAN) or a wide area network (abbreviated as WAN), or the connection may be made to an external computer (for example, via the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, and the module, the program segment, or the portion of codes includes one or more executable instructions for implementing specified logical functions. It should also be noted that, in some alternative implementations, the functions noted in the blocks may also occur out of the order noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special purpose hardware-based system that performs the specified functions or operations, or may also be implemented by a combination of special purpose hardware and computer instructions.

The units or modules involved in the embodiments of the present disclosure may be implemented in a software manner or in a hardware manner. Among them, the name of a unit or module does not constitute a limitation on the unit itself under certain circumstances.

The functions described herein above may be performed, at least partially, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

In a first aspect, according to one or more embodiments of the present disclosure, a data transmission method based on a cloud network is provided, including:
receiving first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification; constructing a first-level query parameter based on the target address and the service object identification, and querying a first routing table based on the first-level query parameter to obtain a query result, wherein the first routing table includes at least a target entry, the target entry is a query result corresponding to at least two first-level query parameters with different parameter values, and the target entry is used to jump to a second routing table; and in response to the query result being the target entry, obtaining a server address of the second virtualized service unit based on the second routing table, and sending the first communication data to the second virtualized service unit based on the server address.

According to one or more embodiments of the present disclosure, the first routing table is stored in a ternary content addressable memory of a programmable switch, and the second routing table is stored in a static random access memory of the programmable switch.

According to one or more embodiments of the present disclosure, the first routing table is a virtual private cloud routing table, and the first-level query parameter includes a subnet address corresponding to the target address and the service object identification; and querying the first routing table based on the first-level query parameter to obtain the query result includes: querying a customized entry in the virtual private cloud routing table based on a first data pair consisting of the service object identification and the subnet address; and in response to the first data pair hitting the customized entry, determining the query result as a target customized entry hit by the first data pair, or in response to the first data pair not hitting any customized entry, determining the query result as the target entry.

According to one or more embodiments of the present disclosure, the second routing table is used to represent a mapping relationship between a virtual address belonging to a different subnet address and a corresponding server address in the independent virtual network environment, and obtaining the server address of the second virtualized service unit based on the second routing table includes: constructing a second-level query parameter based on the service object identification and the target address; and querying the second routing table based on the second-level query parameter to obtain the server address of the second virtualized service unit.

According to one or more embodiments of the present disclosure, querying the second routing table based on the second-level query parameter to obtain the server address of the second virtualized service unit includes: querying the second routing table based on a second data pair consisting of the service object identification and the target address; in response to the second data pair hitting a target virtual address, using a server address corresponding to the target virtual address as the server address of the second virtualized service unit; or in response to the second data pair not hitting any virtual address, discarding the first communication data.

According to one or more embodiments of the present disclosure, the method further includes: obtaining service object configuration information delivered to a control plane of the programmable switch, wherein the service object configuration information is used to register the service object identification; and generating or updating the second routing table based on the service object configuration information.

According to one or more embodiments of the present disclosure, the method further includes: obtaining a third routing table, wherein the third routing table includes at least two candidate routing table entries, the candidate routing table entry is a query result corresponding to a first-level query parameter, and the candidate routing table entry is used to jump to a fourth routing table, wherein the fourth routing table is used to represent a mapping relationship between a virtual address belonging to a same target subnet address and a corresponding server address in a target independent virtual network environment indicated by the first-level query parameter; combining all candidate routing table entries in the third routing table into a target entry, to generate the first routing table; and combining each fourth routing table based on the independent virtual network environment and the corresponding subnet address, to generate the second routing table.

In a second aspect, according to one or more embodiments of the present disclosure, a data transmission apparatus based on a cloud network is provided, including:
a receiving module, configured to receive first communication data sent by a first virtualized service unit, wherein the first communication data includes a target address and a service object identification, the target address is a virtual address of a second virtualized service unit that receives the first communication data, and the first virtualized service unit and the second virtualized service unit belong to an independent virtual network environment represented by the service object identification;
a querying module, configured to construct a first-level query parameter based on the target address and the service object identification, and query a first routing table based on the first-level query parameter to obtain a query result, wherein the first routing table includes at least a target entry, the target entry is a query result corresponding to at least two first-level query parameters with different parameter values, and the target entry is used to jump to a second routing table; and
a processing module, configured to in response to the query result being the target entry, obtain a server address of the second virtualized service unit based on the second routing table, and send the first communication data to the second virtualized service unit based on the server address.

According to one or more embodiments of the present disclosure, the first routing table is stored in a ternary content addressable memory of a programmable switch, and the second routing table is stored in a static random access memory of the programmable switch.

According to one or more embodiments of the present disclosure, the first routing table is a virtual private cloud routing table, and the first-level query parameter includes a subnet address corresponding to the target address and the service object identification; and when querying the first routing table based on the first-level query parameter to obtain the query result, the querying module is further configured to: query a customized entry in the virtual private cloud routing table based on a first data pair consisting of the service object identification and the subnet address; and in response to the first data pair hitting the customized entry, determining the query result as a target customized entry hit by the first data pair, or in response to the first data pair not hitting any customized entry, determining the query result as the target entry.

According to one or more embodiments of the present disclosure, the second routing table is used to represent a mapping relationship between a virtual address belonging to a different subnet address and a corresponding server address in the independent virtual network environment, and obtaining the server address of the second virtualized service unit based on the second routing table includes: constructing a second-level query parameter based on the service object identification and the target address; and querying the second routing table based on the second-level query parameter to obtain the server address of the second virtualized service unit.

According to one or more embodiments of the present disclosure, when querying the second routing table based on the second-level query parameter to obtain the server address of the second virtualized service unit, the processing module is further configured to: query the second routing table based on a second data pair consisting of the service object identification and the target address; in response to the second data pair hitting a target virtual address, using a server address corresponding to the target virtual address as the server address of the second virtualized service unit; or in response to the second data pair not hitting any virtual address, discarding the first communication data.

According to one or more embodiments of the present disclosure, the processing module is further configured to: obtain service object configuration information delivered to a control plane of the programmable switch, wherein the service object configuration information is used to register the service object identification; and generate or update the second routing table based on the service object configuration information.

According to one or more embodiments of the present disclosure, the processing module is further configured to: obtain a third routing table, wherein the third routing table includes at least two candidate routing table entries, the candidate routing table entry is a query result corresponding to a first-level query parameter, and the candidate routing table entry is used to jump to a fourth routing table, wherein the fourth routing table is used to represent a mapping relationship between a virtual address belonging to a same target subnet address and a corresponding server address in a target independent virtual network environment indicated by the first-level query parameter; combine all candidate routing table entries in the third routing table into a target entry, to generate the first routing table; and combine each fourth routing table based on the independent virtual network environment and the corresponding subnet address, to generate the second routing table.

In a third aspect, according to one or more embodiments of the present disclosure, an electronic device is provided, including: at least one processor and a memory;
where the memory stores a computer-executable instruction; and
the at least one processor executes the computer-executable instruction stored in the memory, to cause the at least one processor to perform the data transmission method based on a cloud network according to the first aspect and various possible designs of the first aspect.

In a fourth aspect, according to one or more embodiments of the present disclosure, a computer-readable storage medium is provided. The computer-readable storage medium stores a computer-executable instruction, and when a processor executes the computer-executable instruction, the data transmission method based on a cloud network according to the first aspect and various possible designs of the first aspect is implemented.

In a fifth aspect, according to one or more embodiments of the present disclosure, a computer program product is provided, including a computer program, wherein the computer program, when executed by a processor, implements the data transmission method based on a cloud network according to the first aspect and various possible designs of the first aspect.

The above description is merely preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although operations are depicted in a specific order, it should not be understood as requiring these operations to be performed in a specific order shown or in a sequential order. Under certain circumstances, multitasking and parallel processing may be advantageous. Similarly, although the above discussion contains several specific implementation details, these should not be interpreted as limiting the scope of the present disclosure. Certain features that are described in the context of separate embodiments can also be implemented in combination in a single embodiment. On the contrary, various features described in the context of a single embodiment can also be implemented in multiple embodiments individually or in any suitable sub-combination.

Although the subject matter has been described in language specific to structural features and/or method logical acts, it should be understood that the subject matter defined in the appended claims is not necessarily limited to the specific features or acts described above. On the contrary, the specific features and acts described above are merely example forms for implementing the claims.

I/We claim:

1. A data transmission method based on a cloud network, comprising:
receiving first communication data sent by a first virtualized service unit, wherein the first communication data comprises a target address and a service object identification, the target address is a virtual address of a second virtualized service unit that receives the first communication data, and the first virtualized service unit and the second virtualized service unit belong to an independent virtual network environment represented by the service object identification;
constructing a first-level query parameter based on the target address and the service object identification, and querying a first routing table based on the first-level query parameter to obtain a query result, wherein the first routing table comprises at least a target entry, the target entry is a query result corresponding to at least two first-level query parameters with different parameter values, and the target entry is used to jump to a second routing table; and
in response to the query result being the target entry, obtaining a server address of the second virtualized service unit based on the second routing table, and sending the first communication data to the second virtualized service unit based on the server address.

2. The method according to claim 1, wherein the first routing table is stored in a ternary content addressable memory of a programmable switch, and the second routing table is stored in a static random access memory of the programmable switch.

3. The method according to claim 1, wherein the first routing table is a virtual private cloud routing table, and the first-level query parameter comprises a subnet address corresponding to the target address and the service object identification; and
wherein querying the first routing table based on the first-level query parameter to obtain the query result comprises:
querying a customized entry in the virtual private cloud routing table based on a first data pair consisting of the service object identification and the subnet address; and
in response to the first data pair hitting the customized entry, determining the query result as a target customized entry hit by the first data pair, or in response to the first data pair not hitting any customized entry, determining the query result as the target entry.

4. The method according to claim 1, wherein the second routing table is used to represent a mapping relationship between a virtual address belonging to a different subnet address and a corresponding server address in the independent virtual network environment, and wherein obtaining the server address of the second virtualized service unit based on the second routing table comprises:
constructing a second-level query parameter based on the service object identification and the target address; and
querying the second routing table based on the second-level query parameter to obtain the server address of the second virtualized service unit.

5. The method according to claim 4, wherein querying the second routing table based on the second-level query parameter to obtain the server address of the second virtualized service unit comprises:
querying the second routing table based on a second data pair consisting of the service object identification and the target address; and
in response to the second data pair hitting a target virtual address, using a server address corresponding to the target virtual address as the server address of the second virtualized service unit; or
in response to the second data pair not hitting any virtual address, discarding the first communication data, and using a null address as the server address of the second virtualized service unit.

6. The method according to claim 1, further comprising:
obtaining service object configuration information delivered to a control plane of a programmable switch, wherein the service object configuration information is used to register the service object identification;
obtaining a routing rule corresponding to the service object identification based on the service object configuration information; and
generating or updating the second routing table based on the routing rule corresponding to the service object identification.

7. The method according to claim 1, further comprising:
obtaining a third routing table, wherein the third routing table comprises at least two candidate routing table entries, the candidate routing table entry is a query result corresponding to a first-level query parameter, and the candidate routing table entry is used to jump to the second routing table based on the first-level query parameter; and
combining all candidate routing table entries in the third routing table into a target entry, to generate the first routing table.

8. An electronic device, comprising: a processor and a memory;
wherein the memory stores a computer-executable instruction; and
the processor executes the computer-executable instruction stored in the memory, to cause the processor to perform a data transmission method based on a cloud network comprising:
receiving first communication data sent by a first virtualized service unit, wherein the first communication data comprises a target address and a service object identification, the target address is a virtual address of a second virtualized service unit that receives the first communication data, and the first virtualized service unit and the second virtualized service unit belong to an independent virtual network environment represented by the service object identification;
constructing a first-level query parameter based on the target address and the service object identification, and querying a first routing table based on the first-level query parameter to obtain a query result, wherein the first routing table comprises at least a target entry, the target entry is a query result corresponding to at least two first-level query parameters with different parameter values, and the target entry is used to jump to a second routing table; and
in response to the query result being the target entry, obtaining a server address of the second virtualized service unit based on the second routing table, and sending the first communication data to the second virtualized service unit based on the server address.

9. The electronic device according to claim 8, wherein the first routing table is stored in a ternary content addressable memory of a programmable switch, and the second routing table is stored in a static random access memory of the programmable switch.

10. The electronic device according to claim 8, wherein the first routing table is a virtual private cloud routing table, and the first-level query parameter comprises a subnet address corresponding to the target address and the service object identification; and
wherein querying the first routing table based on the first-level query parameter to obtain the query result comprises:
querying a customized entry in the virtual private cloud routing table based on a first data pair consisting of the service object identification and the subnet address; and
in response to the first data pair hitting the customized entry, determining the query result as a target customized entry hit by the first data pair, or in response to the first data pair not hitting any customized entry, determining the query result as the target entry.

11. The electronic device according to claim 8, wherein the second routing table is used to represent a mapping relationship between a virtual address belonging to a different subnet address and a corresponding server address in the independent virtual network environment, and wherein obtaining the server address of the second virtualized service unit based on the second routing table comprises:
constructing a second-level query parameter based on the service object identification and the target address; and
querying the second routing table based on the second-level query parameter to obtain the server address of the second virtualized service unit.

12. The electronic device according to claim 11, wherein querying the second routing table based on the second-level query parameter to obtain the server address of the second virtualized service unit comprises:
querying the second routing table based on a second data pair consisting of the service object identification and the target address; and
in response to the second data pair hitting a target virtual address, using a server address corresponding to the target virtual address as the server address of the second virtualized service unit; or
in response to the second data pair not hitting any virtual address, discarding the first communication data, and using a null address as the server address of the second virtualized service unit.

13. The electronic device according to claim 8, wherein the method further comprises:
obtaining service object configuration information delivered to a control plane of a programmable switch, wherein the service object configuration information is used to register the service object identification;
obtaining a routing rule corresponding to the service object identification based on the service object configuration information; and
generating or updating the second routing table based on the routing rule corresponding to the service object identification.

14. The electronic device according to claim 8, wherein the method further comprises:
obtaining a third routing table, wherein the third routing table comprises at least two candidate routing table entries, the candidate routing table entry is a query result corresponding to a first-level query parameter, and the candidate routing table entry is used to jump to the second routing table based on the first-level query parameter; and
combining all candidate routing table entries in the third routing table into a target entry, to generate the first routing table.

15. A non-transitory computer-readable storage medium, wherein the computer-readable storage medium stores a computer-executable instruction, and when a processor executes the computer-executable instruction, a data transmission method based on a cloud network is implemented, wherein the method comprises:
receiving first communication data sent by a first virtualized service unit, wherein the first communication data comprises a target address and a service object identification, the target address is a virtual address of a second virtualized service unit that receives the first communication data, and the first virtualized service unit and the second virtualized service unit belong to an independent virtual network environment represented by the service object identification;
constructing a first-level query parameter based on the target address and the service object identification, and querying a first routing table based on the first-level query parameter to obtain a query result, wherein the first routing table comprises at least a target entry, the target entry is a query result corresponding to at least two first-level query parameters with different parameter values, and the target entry is used to jump to a second routing table; and
in response to the query result being the target entry, obtaining a server address of the second virtualized service unit based on the second routing table, and sending the first communication data to the second virtualized service unit based on the server address.

16. The non-transitory computer-readable storage medium according to claim 15, wherein the first routing table is stored in a ternary content addressable memory of a programmable switch, and the second routing table is stored in a static random access memory of the programmable switch.

17. The non-transitory computer-readable storage medium according to claim 15, wherein the first routing table is a virtual private cloud routing table, and the first-level query parameter comprises a subnet address corresponding to the target address and the service object identification; and
wherein querying the first routing table based on the first-level query parameter to obtain the query result comprises:
querying a customized entry in the virtual private cloud routing table based on a first data pair consisting of the service object identification and the subnet address; and
in response to the first data pair hitting the customized entry, determining the query result as a target customized entry hit by the first data pair, or in response to the first data pair not hitting any customized entry, determining the query result as the target entry.

18. The non-transitory computer-readable storage medium according to claim 15, wherein the second routing table is used to represent a mapping relationship between a virtual address belonging to a different subnet address and a corresponding server address in the independent virtual network environment, and wherein obtaining the server address of the second virtualized service unit based on the second routing table comprises:
constructing a second-level query parameter based on the service object identification and the target address; and
querying the second routing table based on the second-level query parameter to obtain the server address of the second virtualized service unit.

19. The non-transitory computer-readable storage medium according to claim 18, wherein querying the second routing table based on the second-level query parameter to obtain the server address of the second virtualized service unit comprises:
querying the second routing table based on a second data pair consisting of the service object identification and the target address; and
in response to the second data pair hitting a target virtual address, using a server address corresponding to the target virtual address as the server address of the second virtualized service unit; or
in response to the second data pair not hitting any virtual address, discarding the first communication data, and using a null address as the server address of the second virtualized service unit.

20. The non-transitory computer-readable storage medium according to claim 15, wherein the method further comprises:
obtaining service object configuration information delivered to a control plane of a programmable switch, wherein the service object configuration information is used to register the service object identification;
obtaining a routing rule corresponding to the service object identification based on the service object configuration information; and
generating or updating the second routing table based on the routing rule corresponding to the service object identification.
